(19) United States
(12) Patent Application Publication
(10) Pub. No.: US 2019/0130707 A1
(43) Pub. Date: May 2, 2019

(54) EVENT NOTIFICATION USING AN INTELLIGENT DIGITAL ASSISTANT

(71) Applicant: Ecolink Intelligent Technology, Inc., Carlsbad, CA (US)

(72) Inventor: Brandon Gruber, San Marcos, CA (US)

(21) Appl. No.: 15/799,393

(22) Filed: Oct. 31, 2017

(51) Int. Cl. G08B 3/10; G08B 19/00

(52) U.S. Cl. CPC G08B 3/1016; H04L 67/306; G08B 19/00

(57) ABSTRACT

A system for providing user-defined event notifications is describe. The system typically comprises an intelligent digital assistant coupled to a local area network for receiving an audible event definition from a user, an electronic system coupled to the local area network for determining whether a first user-defined event has occurred, and an event detection and notification server, coupled to the intelligent digital assistant and the first electronic system via a wide-area network. The event detection and notification system receives an audible event definition from the intelligent digital assistant, interpret the audible event definition to determine that the first user-defined event is present, identify the first electronic system as a system that determines whether the event occurs, determine that the first user-defined event occurred communications with the first electronic system, and provide a notification to the user that the first user-defined event has occurred.

### BACKGROUND

### I. Field of Use

The present application relates generally to the home automation and control arts. More specifically, embodiments of the present invention relate to event notifications by intelligent digital assistants.

### II. Description of the Related Art

Intelligent digital assistants are becoming commonplace in today's homes. Products such as Amazon's Echo, Google's Google Home, and Apple's Siri are all examples of these assistants. Typically, such assistants are installed at home, coupled to an existing home Wi-Fi network and placed in a convenient location where they may be used most frequently, such as in a family room or kitchen.

Digital assistances may be programmed, allowing users to customize their assistants so that they can interact with smart appliances in users' homes, check traffic, read headlines from newspapers or website, play games, listen to streaming music, and much more. Amazon's Echo, for example, is programmed by enabling “skills” for the Echo, each skill for providing a different capability to the Echo.

While intelligent digital assistants are capable of many things, they lack an important technical feature which would make them vastly more useful. None of the intelligent digital assistants are able to determine when an event has occurred, and then notify a user that the event occurred. This is because present-day intelligent digital assistants are not designed to “poll” disparate systems for status.

It would be desirable to enable users to audibly define notification events using an intelligent digital assistant.

### SUMMARY

Embodiments of the present invention are directed towards a system and method for providing notifications to user-defined events. In one embodiment, a system for providing user-defined event notifications, comprises an intelligent digital assistant coupled to a local area network for receiving an audible event definition from a user, a first electronic system coupled to the local area network for determining whether a first user-defined event has occurred, and an event detection and notification server, coupled to the intelligent digital assistant and the first electronic system via a wide-area network, the event detection and notification system, comprising, a memory for storing processor-executable instructions and user account information, a network interface to the wide-area network, and a processor coupled to the memory and the network interface for executing the processor-executable instructions that causes the event detection and notification system to receive, by the processor via the network interface, an audible event definition from the intelligent digital assistant, the audible event definition comprising an audible request from a user to the intelligent digital assistant to be notified when the user-defined event occurs, interpret the audible event definition to determine that the first user-defined event is present, identify the first electronic system as a system that determines whether the event occurs, determine that the first user-defined event occurred communications with the first electronic system, and provide, by the processor via the network interface, a notification to the user that the first user-defined event has occurred.

In another embodiment, a method is described, performed by an event detection and notification server, for providing user-defined event notifications, comprising receiving, by a processor via a network interface, a textual interpretation of an audible event instruction from a voice servicing system, the audible event definition comprising an audible request from a user of an intelligent digital assistant to be notified when a first user-defined event occurs, identifying, by the processor from the textual representation, a first electronic system that can determine when the first user-defined event occurs, monitoring, by the processor via the network interface, the first electronic system to determine when the first user-defined event occurs, and providing, by the processor via the network interface, a notification to the user that the first user-defined event has occurred.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a block diagram of a dwelling comprising an intelligent digital assistance coupled to a home security system, a home monitoring system and a heating/cooling system;

FIG. 2 is a functional block diagram of one embodiment of an event determination and notification server as shown in FIG. 1; and

FIG. 3 is a flow diagram of one embodiment of a method, performed by the event determination and notification server as shown in FIGS. 1 and 3, for providing an event notification to a user in response to the user's audible event definition.

### DETAILED DESCRIPTION

Embodiments of the present invention are directed towards intelligent digital assistants that provide event notifications to users based on audible event definitions provided by the users.

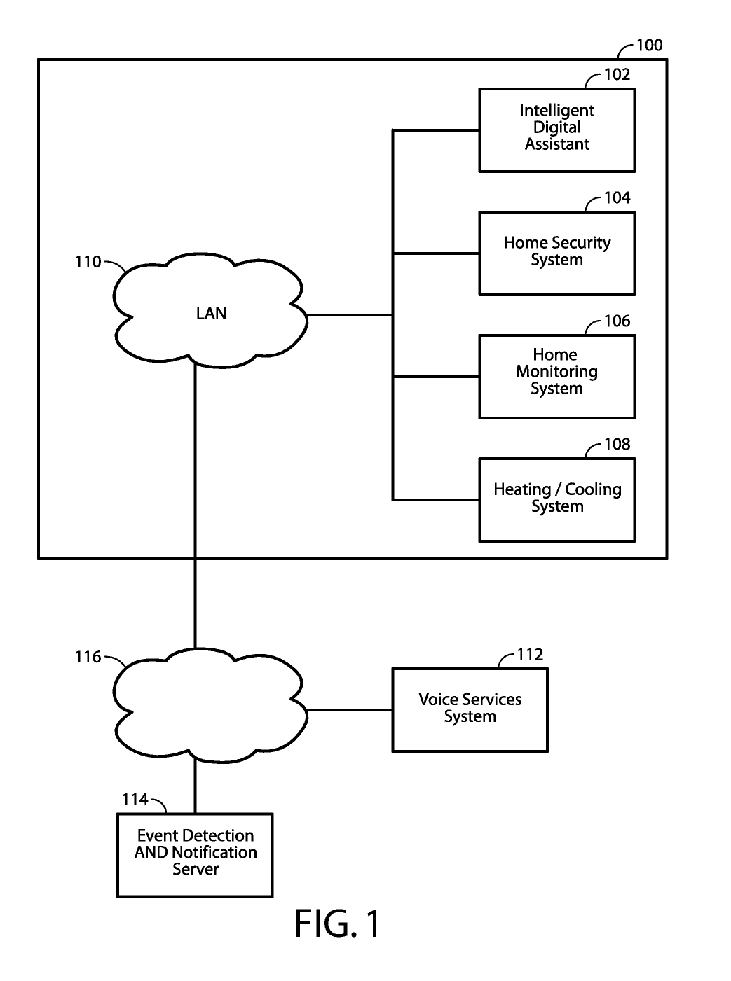

FIG. 1 is a block diagram of a dwelling 100, comprising an intelligent digital assistant 102, a security system 104, a home monitoring system 106, a heating and/or cooling system 108, a local area network (LAN) 110, a remote voice servicing system 112, an event detection and notification server 114, and wide-area network 116. Intelligent digital assistant 102 comprises one of several consumer voice-controlled “smart speakers”, such as the Amazon Echo or the Google Home smart speakers, which may be configured in accordance with embodiments of the present invention. These devices relay voice commands from users to voice servicing system 112 via wide-area network 116, such as the Internet. Voice servicing system 112 comprises one or more cloud-based servers that interpret the voice commands using Automatic Speech Recognition (ASR) and Natural Language Understanding (NLU) processes, then provides the devices with digital instructions based on the voice commands. For example, a user might say, “Alexa, play Satisfaction by the Rolling Stones”. This voice command is received by one or more microphones on intelligent digital assistant 102 and sent via the Internet to voice servicing system 112. Voice servicing system 112 interprets the voice command and, in response, streams Satisfaction to intelligent digital assistant 102 via wide-area network 116. Intelligent digital assistant, in turn, receives the streaming music and plays it for the user via one or more speakers comprising intelligent digital assistant 102.

Intelligent digital assistant 102 may be coupled to one or more home-based electronic systems, such as a home security system 104, home monitoring system 106 and/or an air heating/cooling system 108, among others, via local-area network 110. Local area network 110 typically comprises a wireless Wi-Fi router and gateway that provides wireless connectivity to the Internet and/or to other Wi-Fi enabled devices in dwelling 100.

Home security system 104 may comprises a dedicated security panel coupled to a number of sensors distributed throughout dwelling 100, such as door or window sensors, motion detectors, digital cameras, garage door tilt sensors, etc. The panel may additionally be coupled to a remote monitoring facility for professional security monitoring. The security panel is typically capable of communications over LAN 110.

In another embodiment, home security system 104 comprises a dedicated gateway that is wirelessly coupled to the sensors, rather than a dedicated security panel. The gateway receives signals from the sensors and may send notifications via text, email or phone over LAN 110 and the Internet, to authorized users of home security system 104 when an alarm condition is sensed.

Home monitoring system 106 comprises a dedicated “hub” wirelessly coupled to a number of devices that provide feedback as to various conditions found in dwelling 100. An example of such a home monitoring system is Samsung's SmartThings® home monitoring system. The hub may control devices, such as lights, thermostats, entertainment systems, and other devices, as well as receive status information from flood sensors, freeze sensors, door or window sensors, motion sensors, etc.

Heating/cooling system 108 comprises a thermostat coupled to an air furnace and/or an air cooling device for control of the ambient environment inside dwelling 100. The thermostat may be capable of wireless communications with LAN 110, thus enabling wireless control of the thermostat via a smart device and for receipt of status information from the thermostat, such as current set temperatures, current ambient temperatures, time schedules, etc. An example of such a heating/cooling system is a Nest® intelligent thermostat coupled to a Rheem® furnace and air conditioning unit.

It should be understood that some of the afore-mentioned systems may be capable of performing functions of other systems. For example, home monitoring system 106 may be capable of providing security to dwelling 100 by receiving signals from wireless sensors distributed throughout dwelling 100 and reporting alarm conditions to users via LAN 110 and the Internet.

Intelligent digital assistant 102 may be configured to not only respond to user commands, such as to control lights, play music and get information, but also to pro-actively alert a user when one or more events have occurred, as defined by an audible event definition from a user. For example, a user might say, “Alexa, notify me by text when the garage door is open and it is past 10 pm”. Or, “Alexa, announce when I am leaving and the lights are on”. Or, “Alexa, announce when the air conditioning is on and there is an open door or window”. Or, “Alexa, give me a call when my son comes home from school around 3 pm”. Many other examples are possible that rely on input from one or more electronic systems, such as security system 104, home monitoring system 106 and/or heating/cooling system 108.

An event notification system may be created using intelligent digital assistant 102 and event detection and notification server 114. Event detection and notification server 114 is coupled to voice servicing system 112 either directly (not shown) or via wide-area network 116. In another embodiment, the functionality of event detection and notification server 114 is incorporated into voice servicing system 112. Event detection and notification server 114 receives digitized, interpreted audible event definitions from voice servicing system 112 and processes the information to automatically generate processor-executable instructions to perform the audible event definitions. event detection and notification server 114 then executes the processor-executable instructions to monitor one or more conditions that occur at dwelling 100 and/or events occurring outside dwelling 100 (such as current weather conditions, news events, sporting events, etc.).

A user wishing to set up an event notification may use an “event notification” app downloaded to a user's device, such as a smart phone, tablet computer, etc. The app may allow the user to report one or more electronic systems, such as home security system 104, home monitoring system 106 and heating/cooling system 108) and/or network-connected devices that are located in and around dwelling 100 to event detection and notification server 114. For example, a name, make and/or model number of each system and/or device may be sent, and/or a device's MAC and/or IP address, and/or a protocol or API for allowing event detection and notification server 114 to communicate with each device. Once event detection and notification server 114 has been provided with the identification information for each network-connected device, a user may begin to set event notifications simply by speaking aloud to personal digital assistant 102.

Event detection and notification server 114 stores processor-executable code for determining when a user-defined event has occurred, and for notifying the user in a manner determined by the user in the audible event definitions. These instructions may comprise definitions of a set of possible events that a user may choose via the audible event definition. For example, the set of possible events could comprise a number of variables, set in accordance with the type of electronic systems found in dwelling 100. For example, if dwelling 100 comprises home security system 104 and home monitoring system 106, the variables consist of a set of conditions that each system is able to detect and/or report on. For example, variables related to security system 104 can include a window, a door, a particular window, a particular door, a door or window status (i.e., open, closed, locked or unlocked), motion detected by a motion sensor, a time when a door or window is opened or closed, or when motion is detected. Variables related to home monitoring system might include a light, an appliance, a pump, a particular light, appliance or pump, and a condition of any of the foregoing, such as on or off. Using these variables, a set of event definitions may be created by recognizing key words in an audible event definition to form digital instructions for determining when a simple or complex (more than one event) event occurs, and then notifying the user when the event occurs. In one embodiment, the code for creating digital instructions for determining when events occur from audible event definitions may be referred to as a “skill”, similar in concept as skills used by Amazon's Echo intelligent digital assistant. This executable code may be stored and executed by a processor at voice servicing system 112 or event detection and notification server 114.

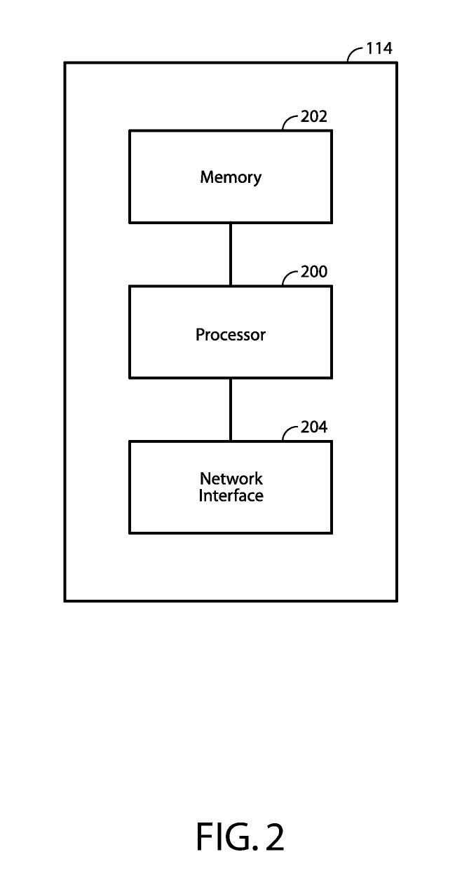

FIG. 2 is a functional block diagram of one embodiment of event detection and notification server 114. FIG. 2 shows processor 200, memory 202, and network interface 204. Some components have been omitted for purposes of clarity, such as a power supply.

Processor 200 comprises one or more general-purpose microprocessors, microcontrollers, custom or semi-custom ASICs, and/or discrete components able to perform event notification to users. Processor 200 may be selected based on processing capabilities, power-consumption properties, and/or cost and size considerations. In the case of a microprocessor, microcontroller, or ASIC, processor 200 generally executes processor-executable instructions stored in memory 202 that control the functionality of event detection and notification server 114. Examples of memory include one or more electronic memories such as RAM, ROM, hard drives, flash memory, EEPROMs, UVPROMs, etc. or virtually any other type of electronic, optical, or mechanical memory device, but excluding propagated signals.

Network interface 204 comprises circuitry necessary to transmit and receive information to and from wide-area network 116 or directly with voice servicing system 112. Such circuitry is well known in the art.

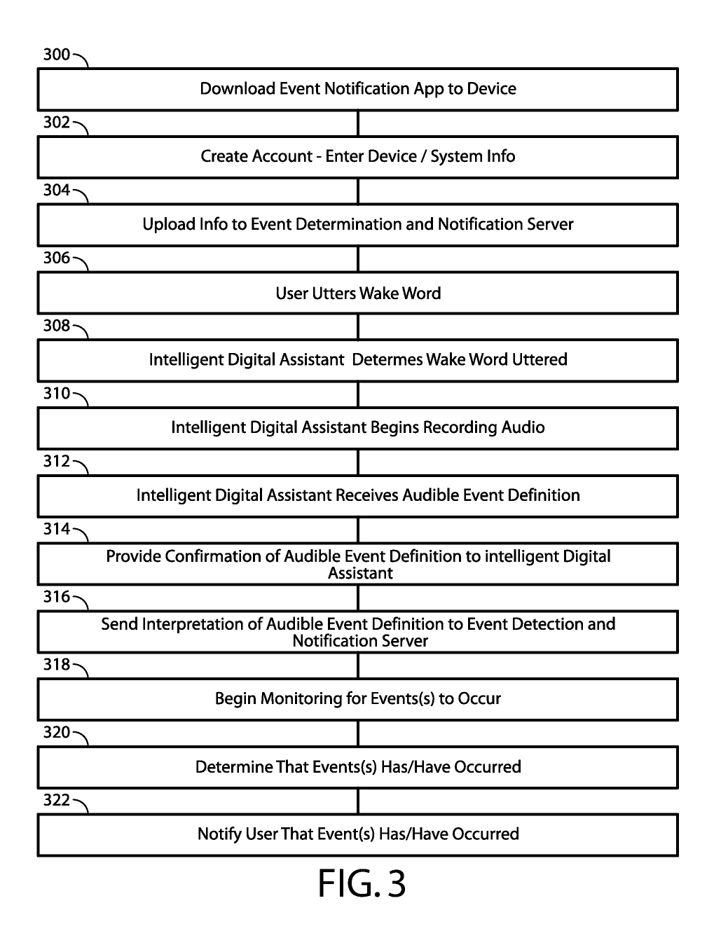

FIG. 3 is a flow diagram of one embodiment of a method, performed by event detection and notification server 114, for providing event notifications to users. It should be understood that the steps described in this method could be performed in an order other than what is shown and discussed and that some minor method steps may have been omitted for clarity and simplicity.

At block 300, a user downloads an event notification app to a user's fixed or mobile device, such as a desktop or laptop computer, smart phone, tablet computer, or the like.

At block 302, the user initiates the event notification app on one of the user's devices and creates an account with such information as the user's name, address, contact information, billing information, etc. The user then provides identification information of any network-connected electronic devices and/or electronic systems within or around dwelling 100 to the app. Alternatively, the app causes the user's device to automatically determine which devices/systems are present in or around dwelling 100, for example, by querying LAN 110 as to any network-connected devices that have received a local IP address from a router in LAN 110 in the past. The user may additionally, or alternatively, provide the name, made and/or model of an electronic system, for example, a Wink® home monitoring system, a Honeywell® 6160 home security system, etc. Account information pertaining to the electronic systems may be provided as well, such as account numbers and passwords.

At block 304, in one embodiment, the user uploads the identification information for each network-connected device/system to event detection and notification server 114, where it is stored in association with the user in the user's account.

At block 306, a user of intelligent digital assistant 102 in the vicinity of intelligent digital assistant 102 utters a “wake word” or phrase that is received by the one or more microphones on intelligent digital assistant 102 and converted into an electronic signal representative of the wake work or phrase. The wake word is a cue for intelligent digital assistant 102 to begin recording audio input received via the one or more microphones.

At block 308, intelligent digital assistant 102 receives the wake word via one or more microphones on intelligent digital assistant 102 and determines that the wake word or phrase was uttered by comparing the a digitized version of the wake word to a wake word or phrase stored in a memory of digital assistant 102, using techniques well-known in the art.

At block 310, in response to determining that a user uttered the wake word or phrase, intelligent digital assistant 102 begins recording audio information from the one or more microphones and stores the audio information in memory 402. The audio information may comprise an audible event definition spoken by a user in proximity to intelligent digital assistant 102, requesting that the user be notified when one or more events occur. “Events” may comprise conditions, or changes in conditions, occurring in or around dwelling 100, such as a door, window or garage door being opened or closed, or being in an open or closed state, motion sensed in a room or outside dwelling 100 or not, one or more lights having a condition of on or off, or being turned on or off, heating/cooling system 108 having a condition of being active or not, or heating/cooling system 108 being turned on or off, a stove having a condition of on or off, or being turned on or off, time of day, date, current or future weather conditions including temperature and precipitation status/forecasts, whether a freezing condition exists or not either inside or outside dwelling 100, or whether a freezing condition has just been entered or exited, whether a flooding condition exists or not either inside or outside dwelling 100, or whether a flooding condition has just been sensed, whether anyone or a particular person has entered a room or dwelling 100, a network-based camera providing still/video images and/or the network-based camera determined to have started sending still/video images. A wide number and variety of conditions may be monitored to determine when a user defined event has occurred. It should be noted that some events may be “polled”, i.e. their status may be determined by inquiry, while other events may be “pushed”, i.e., automatically provided when a change occurs, i.e., a door is opened, motion is sensed, or a camera begins sending photos/video, etc.

At block 312, intelligent digital assistant 102 causes the audible event definition to be sent to voice servicing system 112, such as the Alexa Voice Service servers, via LAN 110 and wide-area network 116 to interpret the audible event definition.

At block 314, in one embodiment, voice servicing system 112 then sends a response back to intelligent digital assistant 102, instructing intelligent digital assistant 102 to provide an audible confirmation to the user that the user's audible event definition was interpreted correctly. For example, if the user's audible event definition was, “Alexa, notify me by text when the garage door is open and it is after 10 pm”, then the response may comprise streaming audio such as, “Ok. You will be notified by text you when the garage door is open and it is after 10 pm”. In one embodiment, an acknowledgement from the user is provided to voice servicing system 112, in order for voice servicing system 112 to continue processing the audible event definition.

At block 316, voice servicing system 112 sends an interpretation of the audible event definition to event detection and notification server 114. In one embodiment, the interpretation is a textual representation of the audible event definition. In another embodiment, where voice servicing system 112 provides the processing for event detection and notification, the audible event definition is processed locally. The remainder of the discussion will apply equally to either embodiment, i.e., further processing performed by voice servicing system 112 or event detection and notification server 114. The interpretation typically comprises generation of a textual version of the audible event definition and/or an identification of key words in the audible event definition. In another embodiment, a list of key words may be provided in a predetermined format. For example, any audible event definition can be arranged as follows:

1. “Notify me/Remind me . . . ” These words, or similar, may be interpreted as an intention for the user to receive an event notification.

2. “by Y . . . ” This portion of the audible event definition provides instructions for notifying the user when the user-defined event occurs, i.e., via text, via email, via phone call, or via audible output from intelligent digital assistant 102. A default method for delivering notifications may be predetermined and stored in the user's account as a preferred notification method, along with contact information pertaining to the preferred notification method. For example, if the preferred communication method is either voice or text, a phone number may be entered by the user into the device running the event notification app. For each type of communication, i.e., text, email, phone call, and audio alert via intelligent digital assistant 102, processor 200 may identify a communication system suitable for delivering a notification of the event. For example, if email is the chosen method for notification, processor 200 will format the notification for transmission via email to an email server in accordance with details stored in memory 202 pertaining to the user's email address.

2. “when X happens/occurs . . . ” “X” is a key word that identifies a first user-defined event. voice servicing system 112/event detection and notification server 114 is programmed to identify, from this portion of the audible event definition, which device or electronic system will determine whether the first user-defined event occurs. Processor 200 limits the identification of devices/electronic systems to those stored in memory 202 in association with the user account, as provided in blocks 302 and 304. Memory 202 may contain a look-up table, listing a number of possible events each with one or more devices/electronic systems that can report such an event as having occurred. Thus, when processor 200 interprets key work “X”, it can determine which device/electronic system to monitor or to expect a push notification from in order to determine whether the first user-defined event has occurred.

3. “and . . . ” This word indicates that the event is conditioned on more than just one condition occurring.

4. “when Z happens/occurs—This is a second user-defined event and indicates that no action should be taken by voice servicing system 112/event detection and notification server 114 until both the first and second user-defined events have occurred. Again, voice servicing system 112/event detection and notification server 114 is programmed to determine, from this portion of the audible event definition, one or more devices or electronic systems to monitor or to expect a push notification from, from the list of devices or electronic systems stored in association with the user's account. Subsequent events may be added to the audible event definition and interpreted by voice servicing system 112/event detection and notification server 114, directing voice servicing system 112/event detection and notification server 114 to monitor and/or receive notifications from other devices. Typically, only when all of the individual events have occurred, or are occurring at the same time, does voice servicing system 112/event detection and notification server 114 provide a notification to the user.

At block 318, processor 200 begins monitoring for the one or more events to occur.

In one embodiment, processor 200 performs an action at a certain time, if time was an “event” specified in the audible event definition. For example, if the audible event definition was “notify when garage door is open and it is after 10 pm”, processor 200 may set an interrupt at 10 pm, or use some other programming technique, to determine when it is 10 pm. At 10 pm, processor 200 may check the status of the garage door, as reported by home security system 104. In another embodiment, processor 200 may determine the status of a front door, to determine whether someone is leaving dwelling 100. In yet another embodiment, processor 200 may check the status of one or more lights via home monitoring system 106. In yet another embodiment, processor 200 may check the status of heating/cooling system 108 to determine if the system is actively heating or cooling dwelling 100. In any of these embodiments, an event may be defined as an action occurring in connection with a predetermined time, such as when a user wants to be notified when a door or window has been open for more than a predetermined time, such as 30 minutes. In this case, processor 200 may determine a time that an event occurs, i.e., determine how long a door or window is open, how long a light has been on, how long heating/cooling system 108 has been active or inactive, etc. Knowing this, processor 200 may compare the event time with a predetermined time as defined, in one embodiment, by the audible event definition.

In one embodiment, processor sends a query to home security system 104 using an API of home security system 104, asking home security system 104 is the garage door is closed or open. Querying electronic systems by processor 200 may be referred to herein as “polling”. Processor 200 may poll upon the occurrence of a predetermined event (such as when a window opens, check heating/cooling system 108 to see if it is on), or at one or more predetermined time intervals, such as once per minute, one every five minutes, etc.

In another embodiment, processor 200, sends a request to one or more electronic systems, asking each system to send a notification to voice servicing system 112/event detection and notification server 114 when an event occurs that matches at least one of the events in the audible event definition. For example, if the audible event definition was “notify when more three or more windows are open and the air conditioning is on”, processor may send a request to security system 104, requesting a notification via LAN 110 and wide-area network 116, when three or more windows are open and a request to heating/cooling system 108, requesting a notification when the air conditioning is on or is turned on. In a related embodiment, processor 200 may request a notification each time a door or window is open from home security system 104, and processor 200 determines when there are three or more windows open. Again, processor 200 may provide the requests to these two electronic systems using APIs in accordance with each electronic system. The technique of requesting notifications may be referred to as “pushing”.

In yet another embodiment, processor 200 automatically connects to a respective server associated with the electronic systems to obtain status information of the system itself, or individual components of each system such as the status of sensors, temperature and humidity conditions from thermostats or the like, energy consumption as reported by power meters, etc. For example, upon knowing that a Wink home monitoring system is installed at dwelling 100 (from blocks 302 and 304), processor 200 may access a user account stored by a Wink server, accessible via wide-area network 116. Processor 200 determine that the Wink system in dwelling 100 comprises a “living room” window sensor, a “master bedroom” window sensor, and a “front door” sensor from information in the user's account stored by the Wink server. Knowing this information, processor may query the Wink server for the status of any particular sensor, or provide the Wink server with a request to be notified when a change in any of the sensors occurs. Generally, when a change occurs in an electronic system such as a Wink system, various information is generated and stored in association with a record of the change. For example, when a light is turned on, a sensor may transmit notice of this condition to the Wink hub. The transmission typically comprises an identification of the sensor, and a description of the change. In this case, a “1” can indicate that the light is on and a “0” can indicate that the light is off. The Wink hub mad add other information to the information sent by the light sensor, such as a time that the light was turned on and a description of which light was turned on, i.e., porch light, kitchen lights, etc. Thus, when a change occurs, an indication of the change may be presented to a respective server and available for provisioning to event detection and notification server 114/voice servicing system 112, either by polling or by pushing.

At block 320, processor 200 determines that the event(s) described in the audible event definition has/have occurred.

At block 322, in response to determining that the event occurred, processor 200 provides a notification to the user in accordance with notification instruction in the audible event definition. Processor 320 uses the contact information provided by the user and stored in the user account to send an email, text alert, or phone call to the user with a message indicating the type of event that has just occurred. The notification is generated in accordance with the notification type (email, text or voice call) and provided to network interface 204, where it is routed accordingly to an email server, text message server or to a cellular or public telephone server. In one embodiment, processor 102 builds the audio notification message using the event components of the audible event definition. For example, if the audible event definition was “notify me when all of my windows are closed”, processor 200 can generate the audio notification message as “All of the windows are closed”, which is the literal event defined in the audible event definition. In one embodiment, not all of the events are recited back to the user in the audio message via an audio stream sent to intelligent digital assistant, which may comprise an audio output module for broadcasting audible notifications. For example, if the audible event definition is “Tell me when the garage door is open and it is after 10 pm”, the audio notification message may state “The garage door is open” without mentioned the time. Whether or not to include events in the audio notification message can be predetermined by the processor-executable instructions, i.e., by a programmer when writing the code that instructs processor 200 how to interpret the audible event definition.

In one embodiment, additionally or alternatively, processor 200 provides an audio notification message to intelligent digital assistant 102, with a message that the event defined by the audible event definition has occurred. The audio notification message may be constructed by processor 200 in the same way as the text, email or phone notification is described above.

The audible event definition may comprise an instruction on how to be notified when a user-defined event occurs. In this case, upon determining that an event has occurred, processor 200 may encode a notification into a format suitable for transmission to the user in accordance with the instruction. Processor 200 may further select a communication system associated with the instruction. For example, if the method of notification in the audible event definition identifies notification by email, processor 200 may identify an email server by accessing the user's account information stored in memory 202. Processor 200 may then transmit the encoded notification to the user via the identified communication system.

In one embodiment, processor 400 sends the audio recording to the remote server only when the estimated user location determined by the visual information matches the estimated user location determined by the audio information when the key word/phrase was spoken. This helps ensure that a follow-up question or command is being spoken from the user who provided the original question/command in block 504, rather than a false signal as a result of someone else simply looking at the intelligent digital assistant.

The methods or steps described in connection with the embodiments disclosed herein may be embodied directly in hardware or embodied in machine-readable instructions executed by a processor, or a combination of both. The machine-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. In the alternative, the processor and the storage medium may reside as discrete components.

Accordingly, an embodiment of the invention may comprise a non-transitory processor-readable media embodying code or machine-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.
300—Download Event Notification App to Device
302—Create Account—Enter Device/System Info
304—Upload Info to Event Determination and Notification Server
306—User Utters Wake Word
308—Intelligent Digital Assistant Begins Determines Wake Word Uttered Recording Audio
310—Intelligent Digital Assistant Begins Recording Audio
312—Intelligent Digital Assistant Receives Audible Event Definition
314—Provide Confirmation of Audible Event Definition to Intelligent Digital Assistant
316—Send Interpretation of Audible Event Definition to Event Detection and Notification Server
318—Begin Monitoring for Event(s) to Occur
320—Determine That Event(s) Has/Have Occurred
322—Notify User That Event(s) Has/Have Occurred

1. A system for providing user-defined event notifications, comprising:
an intelligent digital assistant coupled to a local area network for receiving an audible event definition from a user;
a plurality of electronic systems coupled to the local area network each for determining whether an event has occurred; and
an event detection and notification server, coupled to the intelligent digital assistant and the plurality of electronic systems via a wide-area network, the event detection and notification system, comprising:
a memory for storing processor-executable instructions and user account information;
a network interface to the wide-area network; and
a processor coupled to the memory and the network interface for executing the processor-executable instructions that causes the event detection and notification system to:
receive, by the processor via the network interface, an audible event definition from the intelligent digital assistant, the audible event definition comprising an audible request from a user to the intelligent digital assistant to be notified when a first user-defined event occurs;
interpret the audible event definition to identify from amongst the plurality of electronic systems a one of the plurality of electronic systems that can be used to determine whether the first user-defined event occurs;
determine, based at least in part on signal information generated by the identified one of the plurality of electronic systems, that the first user-defined event has occurred; and
provide, by the processor via the network interface, a notification to the user in response to it being determined that the first user-defined event has occurred.

2. The system of claim 1, wherein the audible event definition further comprises an instruction on how to be notified when the first user-defined event occurs, and the intelligent digital assistant further comprises an audio output module;
wherein the processor-executable instructions further comprise instructions that cause the processor to provide an audio stream to the intelligent digital assistant for audible notification by the audio output module that the first user-defined event has occurred.

3. The system of claim 1, wherein the audible event definition comprises an instruction on how to be notified when the first user-defined event occurs, and the processor-executable instructions that causes the processor to generate the notification further comprises instructions that causes the event detection and notification server to:
encode the alert into a format suitable for transmission to the user in accordance with the instruction;
identify a communication system associated with the instruction; and
transmit, by the processor via the network interface, the notification to the user via the identified communication system.

4. The system of claim 1, wherein the audible event definition comprises an electronic device destination address, and the processor-executable instructions that cause the processor to generate the notification further comprises instructions that causes the intelligent digital assistant to:
encode the notification into a format suitable for transmission to the user in accordance with the electronic device destination address;
determine, by the processor via the network interface, a wide-area communication network over which to transmit the notification in accordance with the electronic device destination address; and
transmit, by the processor via the network interface, the notification to the user via the wide-area communication system.

5. The system of claim 1, wherein the audible event definition further comprises an audible request from the user to the intelligent digital assistant to be notified when a second user-defined event occurs, the instructions cause the event detection and notification system to interpret the audible event definition to identify from amongst the plurality of electronic systems a further one of the plurality of electronic systems that can be used to determine whether the second user-defined event occurs, determine, based at least in part on signal information generated by the identified further one of the plurality of electronic systems, that the first user-defined event has occurred, and provide, by the processor via the network interface, a notification to the user in response to it being determined that the first user-defined event and the second user-defined events have occurred, the identified one of the plurality of electronic systems comprises a home security system, the identified further one of the plurality of electronic systems comprises a home monitoring system, and the audible event definition comprises an instruction to alert the user when the user is leaving a dwelling and that at least one light in the dwelling is on.

6. The system of claim 5, wherein the intelligent digital assistant comprises an audio output module;
wherein the processor-executable instructions comprise further instructions that cause the event determination and notification system to provide an audio stream to the intelligent digital assistant for audible notification by the audio output module that the user is leaving the dwelling and the at least one light is on.

7. The system of claim 1, wherein the audible event definition further comprises an audible request from the user to the intelligent digital assistant to be notified when a second user-defined event occurs, the instructions cause the event detection and notification system to interpret the audible event definition to identify from amongst the plurality of electronic systems a further one of the plurality of electronic systems that can be used to determine whether the second user-defined event occurs, determine, based at least in part on signal information generated by the identified further one of the plurality of electronic systems, that the first user-defined event has occurred, and provide, by the processor via the network interface, a notification to the user in response to it being determined that the first user-defined event and the second user-defined events have occurred, the identified one of the plurality of electronic systems comprises a home security system, the identified further one of the plurality of electronic systems comprises a home monitoring system, and the audible event definition comprises an instruction to alert the user when a door has been opened and that at least one light in the dwelling is on.

8. The system of claim 7, wherein the intelligent digital assistant comprises an audio output module;
wherein the processor-executable instructions comprise further instructions that cause the event determination and notification system to provide an audio stream to the intelligent digital assistant for audible notification by the audio output module that the door has been opened and the at least one light is on.

9. The system of claim 1, wherein the audible event definition further comprises an audible request from the user to the intelligent digital assistant to be notified when a second user-defined event occurs, the instructions cause the event detection and notification system to interpret the audible event definition to identify from amongst the plurality of electronic systems a further one of the plurality of electronic systems that can be used to determine whether the second user-defined event occurs, determine, based at least in part on signal information generated by the identified further one of the plurality of electronic systems, that the first user-defined event has occurred, and provide, by the processor via the network interface, a notification to the user in response to it being determined that the first user-defined event and the second user-defined events have occurred, the identified one of the plurality of electronic systems comprises a home security system, the identified further one of the plurality of electronic systems comprises a home heating and/or cooling system, and the audible event definition comprises an instruction to alert the user when a door or a window is open for more than a predetermined time period and that the heating and/or cooling system is active.

10. The system of claim 9, wherein the intelligent digital assistant comprises an audio output module;
wherein the notification comprises an audible alert sent to the intelligent digital assistant via the audio output module when the door or the window is open for more than the predetermined time period and that the heating and/or cooling system is active.

11. The system of claim 1, wherein the intelligent digital assistant comprises an audio output module, and the processor-executable instructions further comprise;
generate an audio message confirming the audio event instruction; and
providing the audio message to the intelligent digital assistant, wherein the audio output module provides audio confirmation of the audible event definition.

12. A method performed by an event detection and notification server for providing user-defined event notifications, comprising:
receiving, by a processor via a network interface, a textual interpretation of an audible event definition from a voice servicing system, the audible event definition comprising an audible request from a user of an intelligent digital assistant to be notified when a first user-defined event occurs;
identifying, by the processor based upon the textual representation, a first one of a plurality of electronic systems that can be used to determine whether the first user-defined event occurs;
monitoring, by the processor via the network interface, the first one of the plurality of electronic system to determine whether the first user-defined event occurs; and
providing, by the processor via the network interface, a notification to the user in response to it being determined that the first user-defined event has occurred.

13. The method of claim 12, wherein the notification comprises an audio stream for playback by the intelligent digital assistant for audible notification by the intelligent digital assistant that the first user-defined event has occurred.

14. The method of claim 12, wherein the audible event definition comprises an instruction on how to be notified when the first user-defined event occurs, the method further comprising:
encoding the alert into a format suitable for transmission to the user in accordance with the instruction;
identifying a communication system associated with the instruction; and
transmitting, by the processor via the network interface, the notification to the user via the identified communication system.

15. The method of claim 12, wherein the audible event definition comprises an electronic device destination address, the method further comprising:
encoding the notification into a format suitable for transmission to the user in accordance with the electronic device destination address;
determining, by the processor via the network interface, a wide-area communication network over which to transmit the notification in accordance with the electronic device destination address; and
transmitting, by the processor via the network interface, the notification to the user via the wide-area communication system.

16. The method of claim 12, wherein the audible event definition further comprises an audible request from the user of the intelligent digital assistant to be notified when a second user-defined event occurs;
wherein the method further comprises identifying, by the processor based upon the textual representation, a second one of a plurality of electronic systems that can be used to determine whether the second user-defined event occurs;
monitoring, by the processor via the network interface, the second one of the plurality of electronic system to determine whether the second user-defined event occurs; and
providing, by the processor via the network interface, a notification to the user in response to it being determined that the first user-defined event and the second user-defined events have occurred; and
wherein the first one of the plurality of electronic systems comprises a home security system, the second one of the plurality of electronic systems comprises a home monitoring system, and the audible event definition comprises an instruction to alert the user when the user is leaving a dwelling and that at least one light in the dwelling is on.

17. The method of claim 16, wherein the intelligent digital assistant comprises an audio output module, wherein the notification comprises an audio stream that is caused to be provided to the intelligent digital assistant for audible notification by the audio output module.

18. The method of claim 12, wherein the audible event definition further comprises an audible request from the user of the intelligent digital assistant to be notified when a second user-defined event occurs;
wherein the method further comprises identifying, by the processor based upon the textual representation, a second one of a plurality of electronic systems that can be used to determine whether the second user-defined event occurs;
monitoring, by the processor via the network interface, the second one of the plurality of electronic system to determine whether the second user-defined event occurs; and
providing, by the processor via the network interface, a notification to the user in response to it being determined that the first user-defined event and the second user-defined events have occurred; and
wherein the first one of the plurality of electronic systems comprises a home security system, the second electronic system comprises a home monitoring system, and the audible event definition comprises an instruction to alert the user when a door has been opened and that at least one light in the dwelling is on.

19. The method of claim 16, wherein the intelligent digital assistant comprises an audio output module, wherein the notification comprises an audio stream that is caused to be provided to the intelligent digital assistant for audible notification by the audio output module.

20. The method of claim 12, wherein the audible event definition further comprises an audible request from the user of the intelligent digital assistant to be notified when a second user-defined event occurs;
wherein the method further comprises identifying, by the processor based upon the textual representation, a second one of a plurality of electronic systems that can be used to determine whether the second user-defined event occurs;
monitoring, by the processor via the network interface, the second one of the plurality of electronic system to determine whether the second user-defined event occurs; and
providing, by the processor via the network interface, a notification to the user in response to it being determined that the first user-defined event and the second user-defined events have occurred;
wherein the first one of the plurality electronic systems comprises a home security system, the second electronic systems comprises a home heating and/or cooling system, and the audible event definition comprises an instruction to alert the user when a door or a window is open for more than a predetermined time period and that the heating and/or cooling system is active.

21. The method of claim 16, wherein the intelligent digital assistant comprises an audio output module, wherein the notification comprises an audio stream that is caused to be provided to the intelligent digital assistant for audible notification by the audio output module.

22. The method of claim 12, wherein the intelligent digital assistant comprises an audio output module, wherein the method further comprises:
generating an audio message confirming the audio event instruction; and
providing the audio message to the intelligent digital assistant, wherein the audio output module provides audio confirmation of the audible event definition.
